(19) United States
(12) Patent Application Publication
(10) Pub. No.: US 2025/0050892 A1
(43) Pub. Date: Feb. 13, 2025

(54) CONTROL DEVICE

(71) Applicant: TOYOTA JIDOSHA KABUSHIKI KAISHA, Aichi-ken (JP)

(72) Inventors: Yuki TAKAHASHI, Miyoshi-shi (JP); Hiroyuki MORI, Tokyo-to (JP)

(21) Appl. No.: 18/789,697

(22) Filed: Jul. 31, 2024

(30) Foreign Application Priority Data
Aug. 8, 2023 (JP) 2023-129536

(51) Int. Cl. B60W 50/00; B60W 30/09; B60W 30/12; B60W 30/18

(52) U.S. Cl. CPC B60W 50/00; B60W 30/09; B60W 30/12; B60W 30/18163

(57) ABSTRACT

The control device according to one aspect of the present disclosure acquires movement condition data of a moving body, determines a movement mode according to the acquired movement condition data, selects one of a plurality of trained control models according to the result of determining the movement mode, derives a control command for the moving body by using the selected trained control model, and controls the operation of the moving body in accordance with the derived control command. Each trained control model is generated corresponding to the movement mode of the mobile body.

### CROSS REFERENCE TO THE RELATED APPLICATION

This application claims the benefit of Japanese Patent Application No. 2023-129536, filed on Aug. 8, 2023, which is hereby incorporated by reference herein in its entirety.

### BACKGROUND

### Technical Field

The present disclosure relates to a control technology for a mobile body such as an autonomous driving vehicle.

### Description of the Related Art

Japanese Patent Laid-Open No. 2019-533810 proposes a system for autonomous vehicle control configured to determine vehicle commands from routes, GPS data, and sensor data using a trained neural network.

### SUMMARY

One of the objects of the present disclosure is to provide a technique for improving the accuracy of performing the control of a mobile body suitable for the scene.

The control device according to the first aspect of the present disclosure includes a storage unit that stores a plurality of trained control models and a controller. Each of the plurality of trained control models is generated corresponding to a movement mode of a moving body. The controller is configured to perform acquiring movement condition data related to a condition of movement of the mobile body, determining the movement mode according to the acquired movement condition data, selecting one of the plurality of trained control models according to a result of determining the movement mode, deriving a control command for the mobile body by using the selected trained control model, and controlling an operation of the mobile body according to the derived control command. Each of the plurality of trained control models may be configured by a neural network, and deep learning may be used as a machine learning method.

According to the present disclosure, it is possible to improve the accuracy of performing the control of a mobile body suitable for the scene.

### BRIEF DESCRIPTION OF THE DRAWINGS

FIG. 1 schematically indicates an example of a situation in which the present disclosure is applied.

FIG. 2 schematically indicates an example of the control model configuration of the present disclosure.

FIG. 3 schematically indicates an example of the hardware configuration of the control device of the present disclosure.

FIG. 4 indicates an example of a processing procedure related to control by the control device of the present disclosure.

### DESCRIPTION OF THE EMBODIMENTS

According to a conventional method such as Patent Literature 1, an autonomous driving system can be constructed by using a trained machine learning model (in particular, an end-to-end model). However, the present inventors have found that the conventional method has the following problems. For example, the manner of driving can differ greatly depending on the situation, such as lane change, lane keeping, etc. In addition, the probability of occurrence of each scene can differ greatly. In one example, the probability of a lane change occurring at 20 km or more may be less than 1%, which is extremely lower than lane keeping. Furthermore, in the scene of lane change of 1% or less, the probability of avoiding collisions with surrounding vehicles or avoiding obstacles (stationary objects, animals, etc.) on the road is extremely low. In such a state where scenes with greatly different driving manners and occurrence probabilities are mixed, it is assumed that data for learning is collected, and a machine learning model is trained with the collected learning data. In this case, it may be difficult to perform the control of the vehicle that fits the scene with high accuracy in the obtained trained machine learning model. For example, the learning of driving manners with extremely low probability of occurrence is insufficient, which may lead to a decrease in the accuracy of vehicle control by the trained machine learning model. This problem point can occur regardless of the type of vehicle. In addition, such problems are not limited to situations where the vehicle is controlled. In terms of controlling movement, the same applies to mobile bodies other than vehicles. Therefore, the same problem can occur in the scene of controlling any mobile body other than the vehicle.

On the other hand, the control device according to the first aspect of the present disclosure comprises a storage that stores a plurality of trained control models and a controller. Each trained control model is generated corresponding to the movement mode of the mobile body. The controller is configured to perform acquiring movement condition data related to a condition of movement of the mobile body, determining the movement mode according to the acquired movement condition data, selecting one of the plurality of trained control models according to a result of determining the movement mode, deriving a control command for the mobile body by using the selected trained control model, and controlling an operation of the mobile body according to the derived control command.

In the first aspect of the present disclosure, each trained control model is prepared according to the movement mode. That is, each trained control model is provided exclusively for the corresponding movement mode. Since it is not responsible for movement by other movement modes, the machine learning of each control model can reduce the mixing of data from other movement modes (ideally, it collects training data specifically for the corresponding movement mode and generates a trained model with the resulting training data). As a result, it can be expected to improve the accuracy of performing the control of a mobile body that fits the scene.

As another form of the control device according to the above aspects, one aspect of the present disclosure may be an information processing method that realizes all or part of each of the above components, a program, or a non-transitory computer readable medium (storage medium) that can be read by a machine such as a computer that stores such a program. Here, a computer readable medium is a storage medium in which information such as a program is stored by an electrical, magnetic, optical, mechanical, or chemical action.

### 1 Application Example

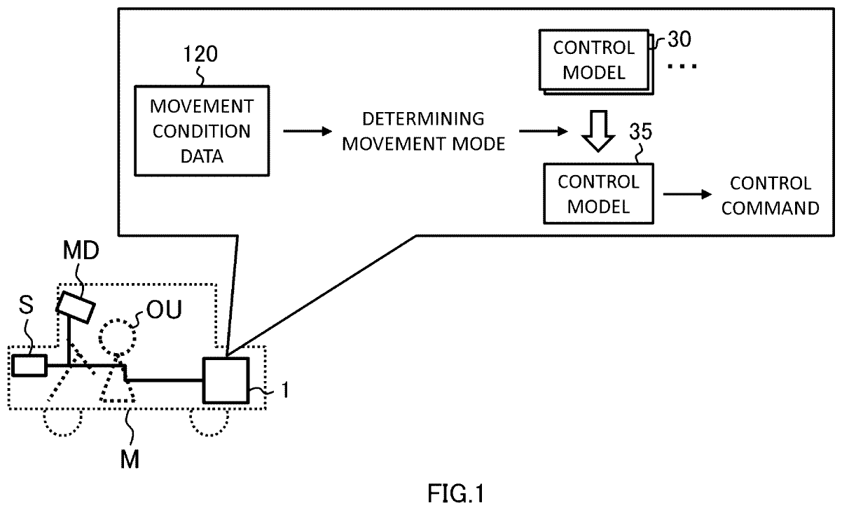

FIG. 1 schematically indicates an example of a scene in which the present disclosure is applied. The control device 1 according to the present embodiment is one or more computers configured to control the automatic movement of the target mobile body M. In the present embodiment, the control device 1 is mounted on the mobile body M and holds a plurality of trained control models 30. Each trained control model 30 is generated corresponding to the movement mode of the mobile body M. That is, each trained control model 30 has acquired the ability to derive a control command for controlling the movement of the mobile body M specifically for the corresponding movement mode.

In the present embodiment, the control device 1 acquires movement condition data 120 related to a condition of movement of the mobile body M. The control device 1 determines a movement mode (driving mode, flight mode, navigation mode, etc.) that conforms to the condition according to the acquired movement condition data 120. The control device 1 selects one of the plurality of trained control models 30 (trained control model 35) according to the result of determining the movement mode. That is, the control device 1 selects a trained control model 35 corresponding to the determined movement mode (movement mode determination result) from a plurality of trained control models 30. The control device 1 derives a control command of the mobile body M in the determined movement mode by using the selected trained control model 35. The control device 1 controls an operation of the mobile body M according to the derived control command. The series of processes from the acquisition of the moving condition data 120 to the control of the mobile body M may be executed in real time.

In the present embodiment, each trained control model 30 is prepared according to the movement mode. That is, since each trained control model 30 is not responsible for movement by other movement modes other than the corresponding movement mode, it is possible to suppress the mixing of training data of other movement modes in the machine learning of each control model 30. Thereby, according to the present embodiment, it can be expected to improve the accuracy of performing the control of the mobile body M that matches the scene. In addition, for some reason, such as specializing in a specific area or adapting to a change in the environment (for example, a road is changed), the control model 30 may be required to be updated by relearning (additional learning). On the other hand, in the present embodiment, when a form in which each trained control model 30 is prepared separately is adopted, only the control model 30 corresponding to the reason may be retrained. Therefore, it is not necessary to update the entire thing, and it can be expected that the update will be more efficient.

### (Mobile Body)

If it can be moved automatically by mechanical control, the type of mobile body M may be appropriately selected according to the embodiment. The mobile body M may be, for example, a movable device such as a vehicle, a flying body, a ship, a robot device, etc. The flying body may be at least one of a manned aircraft and an unmanned aircraft such as a drone. In one example, as shown in FIG. 1, the mobile body M may be a vehicle. The type of vehicle (number of wheels, power source, size, etc.) may be arbitrarily selected. As an exemplary example, the mobile body M may be an automobile having a level 2 or higher autonomous driving ability.

### (Controlling the Operation)

In one example, controlling the operation of the target mobile body M may comprise directly controlling the target mobile body M. In another example, the mobile body M may include a dedicated control device such as a controller. In this case, controlling the operation of the target mobile body M by the control device 1 may comprise indirectly controlling the target mobile body M by giving a derivation result to the dedicated control device. The control device 1 may be deployed at any location. In one example, as shown in FIG. 1, the control device 1 may be mounted on the mobile body M. In another example, the control device 1 may be disposed away from the mobile body M and remotely control the mobile body M. The control device 1 may be configured so that it can be switched at any timing by any operation from the automatic control mode to the manual control mode and from the manual control mode to the automatic control mode of the mobile body M.

### (Control Model)

The control model 30 (35) is configured of a machine learning model having one or more operational parameters that can be adjusted by machine learning. One or more operational parameters are used for the calculation of the desired inference (in this case, the derivation of the control command). Machine learning is adjusting (optimizing) the values of operational parameters by using of training data. The configuration and type of the machine learning model may not be particularly limited and may be appropriately selected according to the embodiment. The machine learning model may be configured by, for example, a neural network, a support vector machine, a regression model, a decision tree model, and the like. The machine learning method may be selected appropriately depending on the machine learning model to be adopted (e.g., backpropagation method, etc.). Machine learning may include supervised learning, unsupervised learning, and reinforcement learning. In one example, at least one of the control models 30 may be at least partially configured by a neural network. The structure of the neural network may be appropriately determined according to the embodiment. The structure of the neural network may be specified, for example, by the number of layers from the input layer to the output layer, the type of each layer, the number of nodes (neurons) included in each layer, the connection relationship between nodes in each layer, and the like. In one example, the neural network may have a recursive structure. Furthermore, the neural network may include any layer, such as a fully connected layer, a convolutional layer, a pooling layer, a deconvolutional layer, an unpooling layer, a normalization layer, a dropout layer, and an LSTM (Long short-term memory). The neural network may have an arbitrary mechanism such as an attention mechanism. The neural network may include any model such as a GNN (Graph neural network), a diffusion model, a generative model (for example, a Generative Adversarial Network, a Transformer, etc.). When a neural network is used for a control model, the weight of the coupling between each node included in the control model and the threshold value of each node are examples of operational parameters. When the machine learning model is employed, the control model may be configured with an end-to-end model structure.

Each control model 30 is constructed to derive control commands according to the environment of the mobile body M. The environment is an event observed at least on the mobile body M itself and its surroundings. In one example, at least a portion of the environment may be observed by one or more sensors S disposed inside or outside the mobile body M. If the sensor S can observe any moving environment of the mobile body M, the type may not be particularly limited, and may be appropriately selected according to the embodiment. In one example, one or more sensors S may include an image sensor (camera), a radar, LiDAR (Light Detection And Ranging), sonar (ultrasonic sensor), an infrared sensor, a GNSS (Global Navigation Satellite System)/GPS (Global Positioning Satellite) module, and the like. The sensor S may be appropriately disposed to observe any direction such as the front, right side, left side, and rear of the mobile body M. If the mobile body M is a vehicle, the sensor S may include at least one of an electronic inner mirror (EIM), a panoramic view monitor (PVM), and a millimeter-wave radar. The electronic inner mirror may be configured by an image sensor installed at the rear of the vehicle. The panoramic view monitor may be configured with image sensors installed in front, on each side, and behind the vehicle. A plurality of millimeter-wave radars may be installed on each side in front of the vehicle and on each side of the rear.

If the control command can be derived from the environment of the mobile body M, the input/output format of each control model 30 may be appropriately selected according to the embodiment. In one example, at least one of the multiple control models 30 may be configured to derive a control command from observation data of a sensor S at one or more points in time. For example, the control model 30 may be configured to perform peripheral recognition, path planning (path/trajectory planning), and motion planning (motion/control planning) (end-to-end model). In another example, at least one of the control models 30 may be configured to derive control commands from the recognition results of the surrounding environment. In this case, the control device 1 may further include an analysis model for inferring a recognition result of the surrounding environment from the observation data of the sensor S. Alternatively, at least one of the control models 30 may include such an analysis model. The analysis model may be appropriately configured. In one example, the analysis model may be configured by a machine learning model. Further, other information may optionally be added to the input of at least one of the plurality control models 30. At least one of the plurality control models 30 may be configured to further receive input of arbitrary information such as, for example, set speed, speed limit, travel data, map data, navigation information (route data).

Typically, the plurality of trained control models 30 may be configured separately (independently). However, the configuration of the plurality of trained control models 30 may not be limited to such examples. In one example of the present embodiment, two or more control models of the plurality of trained control models 30 may be configured at least partially integrally. For example, one model may include the analysis model arranged on the input side and n output portions that each derive control commands from the output of the analysis model (n is a natural number of 2 or more). This one model may be considered as n trained control models 30. That is, in the present embodiment, even if the structure of the model is integral, if the model comprises n output units configured to output control commands, holding the model may be regarded as holding n trained control models 30. In this case, since the output units are separate, n trained control models 30 may be considered to be separately configured. Further, a conditional model configured to output according to a given condition may be handled in the same way. That is, the plurality of trained control models 30 may include conditional models configured to output control commands according to input conditions (classes/categories). In this case, by changing the conditions given to the conditional model and repeating the operation of the conditional model, a plurality of control commands corresponding to the given conditions can be derived. Therefore, when one conditional model is configured to correspond to n conditions, holding this one conditional model may be considered to hold n trained control models 30.

### (Control Command)

The control command relates to the operation of the mobile body M. The configuration of the control command may be appropriately selected according to the embodiment. In one example, the control command may consist of acceleration, deceleration, steering, or a combination thereof. Acceleration and deceleration may include gear changes. If at least one of acceleration, deceleration and steering is included, the control command may be expressed by a path. Correspondingly, the control model 30 may be described as a path planner. Further, the control command may further include a command related to the operation of the mobile body M. As an example, when the mobile body M is a vehicle, the control command may include vehicle operations such as blinkers, hazards, horns, communication processing (for example, transmitting data to a center, sending an emergency call, etc.).

Each control model 30 may be configured to directly output a control command or may be configured to indirectly output a control command. In the latter case, a control command may be obtained by executing arbitrary information processing (interpretation processing) on the output of the control model 30. The control command may be configured to directly indicate, for example, the control amount (control instruction value, control output amount) of the mobile body M such as the accelerator control amount, the brake control amount, and the steering wheel steering angle. Alternatively, the control command may be configured to indirectly indicate the control amount of the mobile body M, such as, for example, a path, a state after control, or the like. In this case, by executing an arbitrary information process, a control amount of mobile body M may be obtained from the control command.

In the present embodiment, typically, the control device 1 may execute only the arithmetic processing of the selected trained control model 35 and acquire control commands. In response, the control device 1 may stop the operation of at least a part of the sensor provided in the mobile M, which is not used in the selected trained control model 35 and is used for other trained control models. Thereby, it is expected that the calculation load and the amount of power consumption will be reduced. However, the process of acquiring a control command is not limited to such examples. In another example, the control device 1 may perform arithmetic processing of one or more trained control models that are likely to be used among the plurality of trained control models 30 and acquire one or more control commands. In this case, selecting the trained control model 35 may be configured by selecting a control command derived from the trained control model 35 (a control command used for control) from one or more control commands. As a result, it is possible to increase the responsiveness to switching movement modes. Note that one or more trained control models that are likely to be used may be selected by any method from the plurality of trained control models 30. In one example, one or more trained control models used for deriving control commands may be selected according to the movement scene such as location, route, type of passage (in the case of a vehicle, for example, a highway, a general road, etc.).

### (Movement Mode)

The movement mode is defined as being able to define a series of modes of movement along a specific purpose such as lane change, lane keeping (keeping), etc. The purpose may be appropriately set for each movement mode according to the type of mobile body M. In one example, if mobile body M is vehicle, then movement mode may include lane change, lane keeping, emergency driving stop system (EDSS), merging yield, automatic parking, or a combination thereof. Lane change is the act of changing the lane in which you are traveling. Lane keeping means continuing to drive in the same lane. An emergency stop is to retreat to the shoulder of the road and stop. Yielding to merge is to give way to another vehicle merging into the lane in which the vehicle is traveling. Automatic parking is to park by automatic control.

For example, movement mode may include lane change, lane keeping, and emergency stop. Accordingly, the plurality of trained control models 30 may include a first trained control model for lane change, a second trained control model for lane keeping, and a third trained control model for emergency stop. Determining movement mode may include selecting any mode of lane change, lane keeping, and emergency stop. In one example of this embodiment, in a vehicle equipped with these three modes, improved accuracy in executing control suited to the scene can be expected. However, the type of movement mode may not be limited to these, and the movement mode corresponding to each control model may be set arbitrarily. Note that the movement mode may be read according to the type of mobile body M. For example, when the moving body M is a vehicle, the movement mode may also be referred to as a driving mode. When the moving body M is a flying body, the movement mode may be referred to as a flight mode. When the moving body M is a ship, the movement mode may be referred to as a navigation mode.

Note that the method for determining the movement mode from the movement condition data 120 may not be particularly limited and may be appropriately selected according to the embodiment. In one example, a computational model may be used to determine the movement mode. The computational model may be configured by, for example, a trained machine learning model, a rule-based model, or a combination thereof. The machine learning model may be configured in the same manner as the control model. The rule-based model is configured to match the given input (movement condition data 120) against the rule and derive the determination result of the movement mode according to the matching result (according to the matching rule). The rule may be set manually or at least partially automatically.

### (Generated in Response to Movement Mode)

In the present embodiment, each trained control model 30 is generated corresponding to a movement mode. The generation method may be appropriately selected according to the embodiment. As an example of the generation method, training data (input data given to the control model) may be collected corresponding to each movement mode. The collected training data may be appropriately provided with correct answer data (teacher signals, labels). Thereby, a plurality of data sets each composed by a combination of training data and correct answer data can be obtained. Each trained control model 30 may be generated by performing machine learning using a plurality of data sets collected according to the corresponding movement mode. In other words, the control model 30 may be trained so that the inference result (derivation of the control command) obtained by providing the control model 30 with training data of each data set obtained according to the corresponding movement mode conforms to the corresponding ground truth data. Training may be to adjust the operational parameters of the control model 30. This machine learning can generate each trained control model 30 that has acquired the ability to control the movement of the moving body M according to the corresponding movement mode. In the present embodiment, at least one of the plurality of trained control models 30 is generated according to a movement mode that is different from the movement mode of other trained control models.

### (Movement Condition Data)

The movement condition data 120 relates to the movement condition of the moving body M at the time (current time) of determining the movement mode. The movement condition data 120 may be configured of any type of data that can be used as an explanatory variable in determining the movement mode. In one example, the movement condition data 120 may include location data (e.g., GNSS/GPS module measurement data) and route data. The route data may be configured to indicate a route from the current location to the destination. Route data may be appropriately acquired from the navigation device. The navigation device may be included in the control device 1 or may be provided outside the control device 1 and appropriately connected to the control device 1. The current location may be a position indicated by the position data obtained at the present time. The position data may be composed of sensor data obtained by a positioning module such as a GNSS/GPS module. Accordingly, the sensor S may include a positioning module. The moving condition data 120 may further include map data. The type of map data may be arbitrary. In one example, high-precision map data may be used as the map data. The map data may be acquired from the navigation device or may be held in the control device 1. The position data, route data, and map data may be collectively read as navigation data.

Further, when the moving body M is a vehicle, the moving condition data 120 may further include at least one of the driving data and the reaction data. The driving data may be configured by, for example, data that indicates a driving state such as speed and steering angle. The driving data may be appropriately acquired from the on-board sensor provided in the vehicle. When a form including driving data is employed, the sensor S may include an on-board sensor. The reaction data is constructed to indicate the reaction of the occupant OU riding the vehicle. The reaction data may be composed of, for example, data capable of identifying the reaction of the occupant OU to a run, such as an image, an audio, or operation information via an input device. A monitoring device MD may be used to acquire reaction data. The monitoring device MD may be, for example, an in-vehicle camera, a microphone, an input device (operation button), or the like. The occupant OU may be, for example, a driver, a passenger other than the driver, and the like. By adopting a form that includes reaction data, the feedback of the occupant OU can be reflected in the control. As a result, it can be expected that the control is adapted to the occupant OU. In addition, other data (other sensor data) other than the above may be further used for the determination of the movement mode.

### (Optimized)

The input of each trained control model 30 may be appropriately selected according to the embodiment. In one example, all sensor data may be input in common to each trained control model 30. However, depending on the movement mode, there may be sensor data with a low contribution to the derivation of the control command (i.e., it is redundant). Therefore, in another example, the input of each trained control model 30 may be optimized according to the corresponding movement mode. What is optimized is that at least one of the inputs of the control model (control model 30) is less than the input of other control models, thereby reducing the input to the control model. Being optimized may include that the input is redundant in at least some of the control models if the input is reduced.

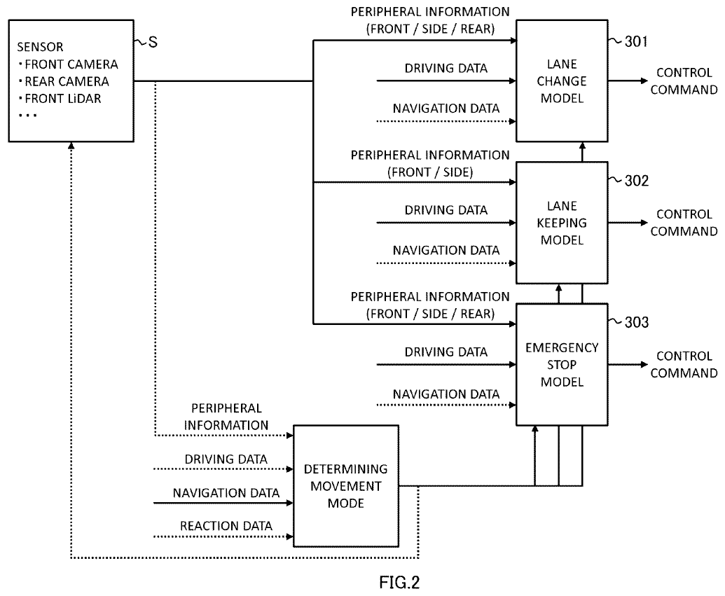

FIG. 2 schematically shows an example of the control model configuration according to the present embodiment. In an example of FIG. 2, mobile body M is vehicle. The sensor S includes a plurality of sensors disposed in front, on each side and back, respectively, and acquires peripheral information (sensor data). Each sensor is, for example, a GPS module, an image sensor (camera), a LiDAR, or the like. The movement condition data 120 includes position data, peripheral information (sensor data), driving data, navigation data (position data, map data, route data), and reaction data. The plurality of trained control models 30 includes a lane change model 301, a lane keeping model 302, and an emergency stop model 303. The lane change model 301 is an example of a first trained control model, the lane keeping model 302 is an example of a second trained control model, and the emergency stop model 303 is an example of a third trained control model. Any of the movement modes of lane change, lane keeping, and emergency stop may be selected according to the movement condition data 120. Depending on the selected movement mode, either the lane change model 301, the lane keeping model 302, and the emergency stop model 303 may be selected as the model to be used for control.

In an example of FIG. 2, each model (301, 302, 303) has driving data and navigation data in common. On the other hand, while the lane change model 301 and the emergency stop model 303 are input with forward, side, and rear sensor data, the lane keeping model 302 is input with forward and side sensor data. That is, rear sensor data is omitted from the input of the lane keeping model 302. This omission is an example of optimization. If the input of the control model 30 is optimized, a sensor that is not used by the selected control model 35 may occur depending on the movement mode. The control device 1 may appropriately stop the operation of the sensor that is not used. In an example of FIG. 2, the control device 1 may stop the operation of the rear sensor while the lane keeping movement mode is selected.

By optimizing the input of each trained control model 30, an improvement in computational efficiency can be expected. For example, it is possible to expect at least one of the following: reduction in power consumption by suppressing the activation of unnecessary sensors, reduction in sensor failure rate by making sensor activation time more efficient, reduction in computational load/amount of computation by optimizing the model, thereby improving computational efficiency, and improvement in the accuracy of model calculations by reducing unnecessary inputs. Note that the control model configuration and optimization form may not be limited to the example in FIG. 2 and may be appropriately selected according to the embodiment. In another example, the plurality of trained control models 30 may further include a trained control model (automatic parking model) corresponding to automatic parking. The sensor S may include a clearance sonar. In this case, the sensor data of the clearance sonar may be omitted from the input of other models, while being input to the automatic parking model. In response, the control device 1 may stop the operation of the clearance sonar while using the other model and activate it when using the automatic parking model.

### (Strength)

In one example, determining the movement mode may include calculating the intensity. Deriving a control command may comprises deriving a control command according to the calculated intensity. The intensity may be appropriately configured to indicate the degree to which the movement is forced to be performed by the target movement mode. Each trained control model 30 may be configured to derive a control command such that the higher the intensity, the more forcibly the movement in that movement mode is executed. For example, the higher the intensity, the smaller the limitation of the execution parameter. As a specific example, in the case of lane changing, the degree to which the lane change is forced may be increased as the intensity increases, for example by executing the lane change earlier, in a narrow space, or by increasing acceleration/deceleration. According to an example of the present embodiment, the degree to which movement in each movement mode is performed can be controlled.

### 2 Configuration Example

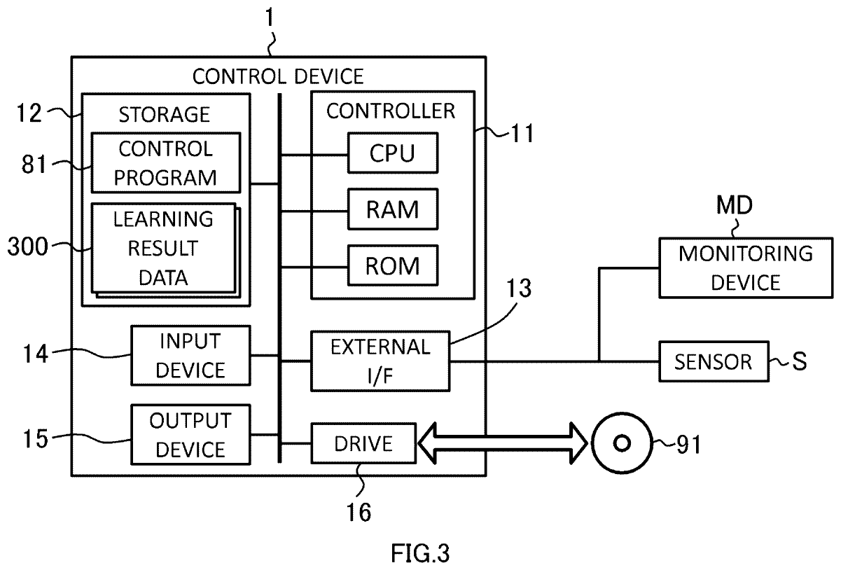

FIG. 3 schematically indicates an example of the hardware configuration of the control device 1 according to the present embodiment. The control device 1 according to the present embodiment is a computer in which the controller 11, the storage 12, the external interface 13, the input device 14, the output device 15, and the drive 16 are electrically connected.

The controller 11 includes a CPU (Central Processing Unit), RAM (Random Access Memory), ROM (Read Only Memory), and the like, and is configured to execute arbitrary information processing based on a program and various data. The controller 11 (CPU) is an example of a processor resource. The storage 12 may be configured by, for example, any storage device such as a hard disk drive or a solid-state drive. The storage 12 (and RAM, ROM) is an example of the storage of the present disclosure. The storage 12 (and RAM, ROM) is an example of a memory resource. In the present embodiment, the storage 12 stores various information such as the control program 81 and the learning result data 300.

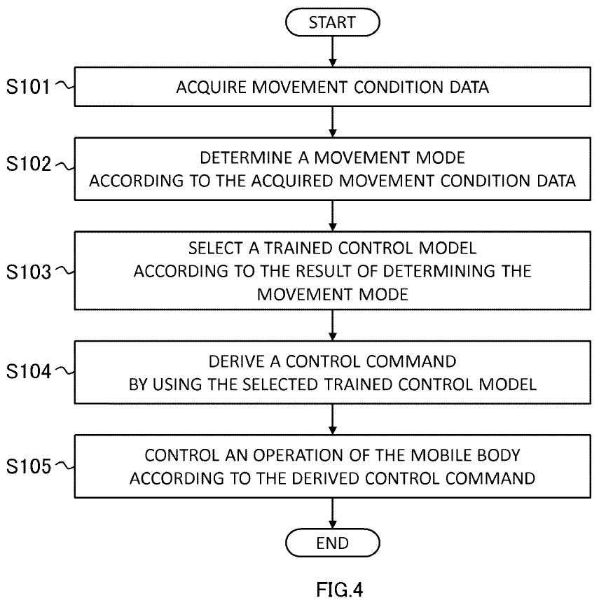

The control program 81 is a program for causing the control device 1 to execute information processing (FIG. 4 described later) for controlling the mobile body M. The control program 81 includes a series of instructions for the information processing. The learning result data 300 is configured to indicate information about the trained control model 30. In one example, the learning result data 300 may be given for each trained control model 30. In another example, one learning result data 300 may be configured to indicate two or more trained control models 30. Further, if the trained control model 30 can be reproduced, the data structure of the learning result data 300 may be appropriately determined according to the embodiment. In one example, the learning result data 300 may include information indicating the value of the operational parameter of the control model 30 adjusted by machine learning. The learning result data 300 may further include information indicating the configuration of the machine learning model (for example, the structure of a neural network).

The external interface 13 may be, for example, a USB (Universal Serial Bus) port, a dedicated port, a wireless communication port, or the like, and is configured to connect to an external device by wire or wirelessly. In the present embodiment, the control device 1 may be connected to the sensor S and the monitoring device MD via the external interface 13. The input device 14 is, for example, a device for performing input such as a mouse, a keyboard, an operator, and the like. The output device 15 is a device for outputting, for example, a display, a speaker, or the like. The input device 14 and the output device 15 may be integrally configured by, for example, a touch panel display or the like.

The drive 16 is a device for reading various information such as a program stored on the storage medium 91. At least one of the control program 81 and the learning result data 300 may be stored on the storage medium 91 instead of or together with the storage 12. The storage medium 91 is configured to store the information by electrical, magnetic, optical, mechanical or chemical action so that a machine such as a computer can read various information (such as a stored program). The control device 1 may acquire at least one of the control program 81 and the learning result data 300 from the storage medium 91. The storage medium 91 may be a disk-type storage medium such as a CD or DVD, or a storage medium other than a disk-type such as a semiconductor memory (for example, flash memory). The type of drive 16 may be appropriately selected according to the type of storage medium 91.

With regard to the specific hardware configuration of the control device 1, the component can be omitted, replaced, and added as appropriate according to the embodiment. For example, the controller 11 may include a plurality of hardware processors. The hardware processor may be configured of a microprocessor, an FPGA (field-programmable gate array), a DSP (digital signal processor), an ECU (Electronic Control Unit), a GPU (Graphics Processing Unit), and the like. At least one of the external interface 13, the input device 14, the output device 15, and the drive 16 may be omitted. The control device 1 may include a communication interface and be configured to perform data communication with an external computer. At least one of the input device 14, the output device 15 and the drive 16 may be connected via an external interface or communication interface. The control device 1 may be a general-purpose computer, a terminal device, or the like in addition to a computer designed exclusively for the service provided. When the mobile body M is a vehicle, the control device 1 may be an in-vehicle device.

### 3 Operation Example

FIG. 4 indicates an example of a processing procedure related to the control of the mobile body M by the control device 1 according to the present embodiment. The controller 11 of the control device 1 executes instructions included in the control program 81 by the CPU. Thereby, the control device 1 operates as a computer capable of performing the following information processing. The following processing procedure is an example of a control method executed by a computer. However, the following processing procedure is only an example, and each step may be modified as much as possible. Further, the following processing steps can be omitted, replaced, and added as appropriate according to the embodiment.

In step S101, the controller 11 acquires the movement condition data 120. The controller 11 may acquire the movement condition data 120 directly or indirectly from a source such as the sensor S. In one example, when the mobile body M is a vehicle, the movement condition data 120 may include reaction data indicating the reaction of the occupant OU riding on the vehicle. The reaction data may be obtained directly or indirectly from the monitoring device MD.

In step S102, the controller 11 determines a movement mode that conforms to the condition of movement according to the acquired movement condition data 120. In one example, determining the movement mode may include calculating the intensity. Further, in an example of FIG. 2, determining the movement mode may include selecting one of the modes of lane change, lane keeping, and emergency stop.

In step S103, the controller 11 selects a trained control model 35 to be used for control from a plurality of trained control models 30 according to the result of determining the movement mode. In one example, the inputs of each trained control model 30 may be optimized according to the corresponding movement mode. In response to this, the controller 11 may activate the operation of the sensor to be used among the sensors included in the sensor S at an arbitrary timing and according to the selection result and stop the operation of the sensor that is not used.

In step S104, the controller 11 derives a control command by using the selected trained control model 35. The controller 11 may appropriately acquire data given to the trained control model 35 at any timing, directly or indirectly from the sensor S or the like. The controller 11 may input the acquired data to the trained control model 35 and execute the arithmetic process of the trained control model 35. Thereby, the controller 11 may obtain the derivation result of the control command from the trained control model 35. When the form for calculating the intensity is adopted, deriving the control command may comprise deriving the control command according to the calculated intensity.

In step S105, the controller 11 controls the operation (movement) of the mobile body M according to the derived control command. When the control of the target mobile body M is completed, the controller 11 ends the processing procedure of the control device 1 according to the present operation example.

The controller 11 may repeatedly execute a series of information processing of steps S101˜S105 at an arbitrary timing. In one example, the controller 11 may repeatedly execute a series of information processing of steps S101˜steps S105 for a predetermined period of time (for example, while the power source of the mobile body M is activated, and the automatic control mode is selected). Thereby, the control device 1 may continuously execute automatic control of the mobile body M.

### [Features]

In the present embodiment, the process of steps S101˜steps S103 selects a trained control model 35 that conforms to the condition of movement from among the plurality of trained control models 30. Then, by the processing of steps S104 and S105, the selected trained control model 35 is used to control the mobile body M. Since each trained control model 30 is not responsible for movement by other movement modes other than the corresponding movement mode, the mixing of training data of other movement modes can be suppressed in the machine learning of each control model 30. With this specialized configuration, it can be expected that each control model 30 acquires the ability to control the operation of the mobile body M in the corresponding movement mode at a high level in machine learning. As a result, in step S105, it is possible to improve the accuracy of performing the control of the mobile body M that matches the scene.

### 4 Modifications

As described above, embodiments of the present disclosure have been described in detail, but the description up to the above is only an example of the present disclosure in all respects. Needless to say, various improvements or modifications can be made without departing from the scope of the present disclosure. In addition, the processes and means described in the present disclosure can be freely combined and implemented as long as no technical contradictions occur.

What is claimed is:

1. A control device comprising:
a storage that stores a plurality of trained control models, and
a controller,
wherein each of the plurality of trained control models is generated corresponding to a movement mode of a mobile body, and
wherein the controller is configured to perform:
acquiring movement condition data related to a condition of movement of the mobile body,
determining the movement mode according to the acquired movement condition data,
selecting one of the plurality of trained control models according to a result of determining the movement mode,
deriving a control command for the mobile body by using the selected trained control model, and
controlling an operation of the mobile body according to the derived control command.

2. The control device according to claim 1, wherein
determining the movement mode includes calculating an intensity, and
the deriving the control command comprises deriving the control command in accordance with the calculated intensity.

3. The control device according to claim 1, wherein
the mobile body is a vehicle,
the plurality of trained control models includes a first trained control model for lane change, a second trained control model for lane keeping, and a third trained control model for emergency stop, and
the determining the movement mode includes selecting one of the modes of the lane change, the lane keeping, and the emergency stop.

4. The control device according to claim 3, wherein
the acquired movement condition data includes reaction data indicating a reaction of an occupant riding the vehicle.

5. The control device according to claim 1, wherein
an input of each of the plurality of trained control models is optimized according to the corresponding movement mode.
